(19) United States
(12) Patent Application Publication
(10) Pub. No.: US 2004/0102994 A1
(43) Pub. Date: May 27, 2004

(54) Method and system for processing sales process information

(76) Inventor: Prasad Boppana, Houston, TX (US)

Correspondence Address: MCANDREWS HELD & MALLOY, LTD, 500 WEST MADISON STREET, SUITE 3400, CHICAGO, IL, 60661

(21) Appl. No.: 10/716,104

(22) Filed: Nov. 18, 2003

Related U.S. Application Data
(60) Provisional application No. 60/427,588, filed on Nov. 19, 2002.
(60) Provisional application No. 60/427,397, filed on Nov. 19, 2002.
(60) Provisional application No. 60/427,602, filed on Nov. 19, 2002.
(60) Provisional application No. 60/427,582, filed on Nov. 19, 2002.

(51) Int. Cl. G06F 17/60

(52) U.S. Cl. 705/1; 705/10

(57) ABSTRACT

Certain embodiments of the invention may be found in a method and system for processing sales process related information to create a sales process. In an embodiment of the invention, the processing of sales process information may include acquiring sales process information from at least one of a plurality of information resources and creating a historical information store using the acquired sales process information. Accordingly, rules may be created based on the acquired sales process information in the historical information store and a resultant sales process may be generated based on at least a portion of the created rules.

### CROSS-REFERENCE TO RELATED APPLICATIONS/INCORPORATION BY REFERENCE

This application makes reference to, claims priority to and claims the benefit of U.S. Provisional Application Serial No. 60/427588 (Attorney Docket No. 14132US01) filed on Nov. 19, 2002.

This application also makes reference to:

U.S. Provisional Application Serial No. 60/427397 (Attorney Docket No. 14136US02 filed on Nov. 19, 2002;

U.S. Provisional Application Serial No. 60/427602 (Attorney Docket No. 14133US02 filed on Nov. 19, 2002; and

U.S. Provisional Application Serial No. 60/427582 (Attorney Docket No. 14137US02 filed on Nov. 19, 2002.

The above stated applications are hereby incorporated herein by reference in their entirety.

### FIELD OF THE INVENTION

Certain embodiments of the invention relate to sales automation in a business environment. More specifically, certain embodiments of the invention relate to a method and system for processing sales process information.

### BACKGROUND OF THE INVENTION

The pervasiveness of information technologies along with data transfer media such as the Internet, have provided an excellent opportunity for customers to tap into a diverse range of services and products and for businesses to provide the necessary products and services to meet customer demands. In this regard, e-business and e-commerce solutions have revolutionized business practices over the past few decades. Notwithstanding, the advantages provided by e-business, e-commerce and various other related information methodologies and technologies, there is a general lack of consolidated sales process information. In general, sales process information may encompass any information and/or tasks that are required to identify customer needs, up to and including any information and/or tasks necessary to consummate a sale. For example, sales process information may include information such as customer needs, customer requirements, customer business and financial data, and past and present customer practices. Current sales paradigms require sellers to access a myriad of systems in order to acquire necessary sales process information to satisfy their business requirements.

A “seller” may refer to an entity sourcing goods and/or services, while a “buyer” may be any entity that receives good and/or services from, for example, a “seller.” Accordingly, depending on which entity is sourcing goods or services in a particular transaction, an entity may be a “seller” in one transaction but be a “buyer” in a subsequent transaction. Similarly, depending on which entity is receiving goods and/or services in a particular transaction, an entity may be “buyer” in a particular transaction, and a “seller” in a subsequent transaction. Additionally, a similar definition may apply to a customer depending on whether a customer is receiving goods and/or services, or sourcing goods and/or services.

The general lack of consolidated information means that sellers typically have to access, for example, a plurality of databases, which may be hosted by a plurality of disparate systems, often requiring various access interfaces and/or methodologies. In this regard, depending on information complexity, location and volume, a seller may require specialized knowledge and training to access multiple systems in order to acquire relevant sales process information necessary to sell its products and/or services. In many instances, a large portion of the acquired sales process information may be irrelevant to the context of the seller's requirements, and hence unusable. Additionally, since sales process information may be stored in various disparate repositories, integration of information may be difficult and in certain cases, may not be readily accessible. Accordingly, not only is the accessibility of information difficult, but general availability and discovery of information may also be severely impacted. The current sales paradigm is not only inefficient, but may often prove to be quite costly since vast amounts of time may be spent searching for pertinent sales process information.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for processing sales information to create a sales process. The processing of sales information may include acquiring sales process information from at least one of a plurality of information resources and creating a historical information store using the acquired sales process information. Rules may be created based on the acquired sales process information in the historical information store and at least one sales process may be generated based on at least a portion of the created rules. In response to a request to create a sales process, a determination may be made as to whether matching sales process information corresponding to the request is located within the historical information store. If matching sales process information corresponding to the request is located in the historical information store, at least a portion of the matching sales process information may be utilized to generate the sales process.

In instances where no matching sales process information corresponding to the request is located in the historical information store, new rules corresponding to the request to create the sales process may be generated. In an aspect of the invention, the new rules may be dynamically generated. Notwithstanding, sales processing steps and/or sales processing activities corresponding to the newly generated rules may be defined. At least one of the sales processing activities and/or the sales processing steps may be selected for generating the sales process. In instances where no matching sales process information corresponding to the request is located in the historical information store, an analogy may be generated based on at least similar sales process information, similar sales processing activities or similar sales processing steps that may be located in the historical information store, in order to generate the sales process. Furthermore, if no matching sales process information corresponding to the request is located in the historical information store, a hypothesis may be created based on sales process information located in the historical information store, in order to generate the sales process.

Another embodiment of the invention may provide a machine-readable storage, having stored thereon, a computer program having at least one code section for processing sales process information. The at least one code section may be executable by a machine, thereby causing the machine to perform the steps as described above for processing sales process information.

Other embodiments of the invention may be found in a system for processing sales process information. The system for processing sales processing information may comprise, a sales integration engine that may be configured to acquire the sales process information from at least one of a plurality of information resources and create a historical information store using the acquired sales process information. The sales integration engine may create rules based on the acquired sales process information in the historical information store and may generate a sales process from at least a portion of the created rules. The sales integration engine may comprise at least one of a data synchronizer, a service scheduler, a service notifier and an integration configurator.

In response to a request to create a sales process, the sales integration engine may be adapted to determine whether matching sales process information corresponding to the request is located in the historical information store. The sales integration engine utilizes at least a portion of the matching sales process information for the generating of the sales process if matching sales process information corresponding to the request is located in the historical information store. The sales integration engine may generate new rules corresponding to the request to create the sales process if no matching sales process information corresponding to the request is located in the historical information store. In this regard, the sales integration engine may dynamically generate the new rules corresponding to the request to create the sales process. Notwithstanding, the sales integration engine may define sales processing steps and/or sales processing activities corresponding to the newly generated rules.

In another aspect of the invention, the sales integration engine may be configured to select at least one of the sales processing activities and/or the sales processing steps for generating the sales process. In instances where no matching sales process information corresponding to the request is located in the historical information store, the sales integration engine may analogize based on at least similar sales process information, similar sales processing activities or similar sales processing steps that may be located in the historical information store, in order to generate the sales process. If no matching sales process information corresponding to the request is located in the historical information store, the sales integration engine may be adapted to hypothesize based on sales process information located in the historical information store, in order to generate the sales process.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a block diagram of a sales processing system having an exemplary sales integration engine in accordance with an embodiment of the invention.

FIG. 1b is a block diagram of an exemplary data synchronization block in accordance with an embodiment of the invention.

FIG. 2 is a block diagram of an exemplary sales process in accordance with an embodiment of the invention.

FIG. 3a is a flow chart of exemplary steps for processing sales processing information in accordance with an aspect of the invention.

FIG. 3b is a flow chart of exemplary steps for generating the sales process of FIG. 3a in accordance with an aspect of the invention.

### DETAILED DESCRIPTION OF THE INVENTION

Certain aspects of the invention may be found in a method and system for processing sales information in order to generate a sales process. Sales process information may be gathered from a plurality of information stores and utilized to create models based on various contexts. Various rules may be defined regarding certain sales processing activities. In response to a request to generate a sales process, the rules may be utilized to provide guidance when creating the sales process. Other aspects of the invention may relate to a method and system for a sales integration engine that may be adapted to generate a sales process.

An aspect of the invention may provide a single consolidated location where a seller may access and acquire sales data and information pertaining to working opportunities required to sell its products offerings. Products may comprise, but are not limited to, goods, whether tangible or intangible, and/or services. An aspect of the invention may also provide real time links between any number of sales processes and external systems which receive and/or distribute sales process information. The sales process information may provide business opportunities and may comprise any information that may be pertinent to creating and maintaining a relationship between a customer or potential customer and a business. Sales processes information may be classified into a plurality of categories or contexts, which may include, but are not limited to, product offering data, channel data, vertical data, geographical data and customer data. An embodiment of the invention provides a sales integration engine which may eliminate, for example, many of the complexities and time required for connecting and interfacing with myriad external systems.

Sales processes may form the backbone for a seller's activities while working on opportunities to sell product offering. Sales processes may be modeled to simulate various phases of a sales process selling cycle. These phases may include, but are not limited to, customer needs identification, decision making identification, product and/or service demonstration and return on investment. Each phase may comprise a series of activities that may have to be completed in order to progress through the sales process selling cycle. In some instances, one or more of the activities in a sales process selling cycle may require that certain pre-conditions or contents be fulfilled before an activity may be completed. Information needed to complete an activity or to satisfy a pre-condition may vary depending on a number of parameters. In an exemplary case where a return on investment (ROI) analysis task is required, some of these parameters may include, but are not limited to, one or more base documents that may be required to create the ROI and the revenue generated over the last fiscal year and/or last quarter. Similarly, exemplary activities may include, but are not limited to, collection of revenue information, illustration of earnings growth and determination of investment growth. Accordingly, aspects of the invention may also provide a system and method for efficiently fulfilling pre-conditions and activities that may be necessary for completing a sales process selling cycle.

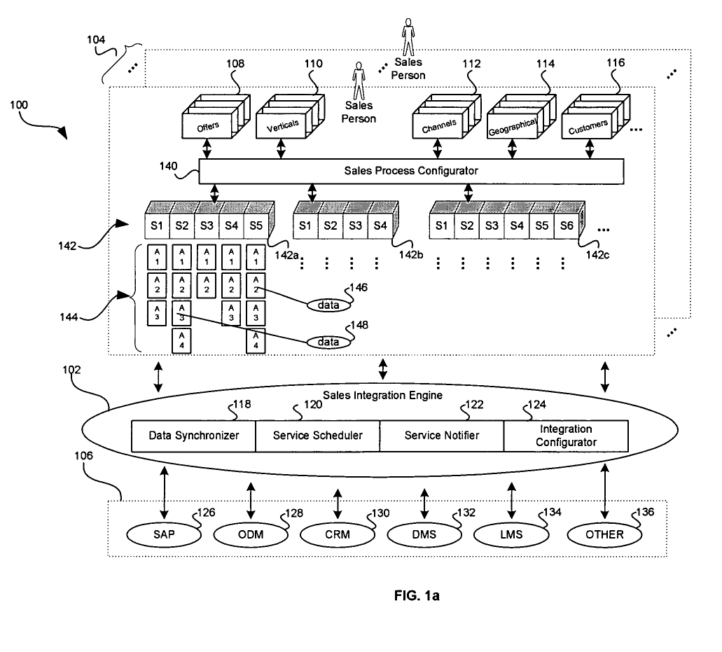

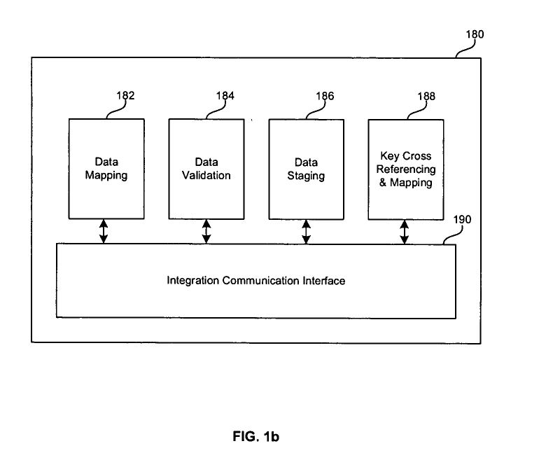

FIG. 1a is a block diagram of sales processing system 100 having an exemplary sales integration engine block 102 in accordance with an embodiment of the invention. Referring to FIG. 1a, there is shown a sales integration engine or block 102, customer opportunities and data blocks collectively referred to as 104, and an information resources block 106.

The sales integration engine 102 may comprise suitable software and/or hardware that may be adapted to connect the activities from any number of processes in any context, to any external system, and to send, receive and process sales process information in real time and/or or at some time subsequent to the acquisition of the sales process information. The sales integration engine 102 may be based on a sales integration framework, which may contain a plurality of sub-components, which may be adapted to provide one or more services necessary to connect to and manage data exchange between one or more sales processes and one or more external systems. Since sales process information required by sellers to access working opportunities in order to sell product offerings may be made available or accessible in one consolidated location, the sales integration engine 102 may remove the complexities and time required for connecting and interfacing with the external systems. The hardware may comprise a computer platform, for example, a personal computer, a server, a mainframe computer and/or other specialized computer system that may be configured to handle connection of the activities for processes in any context to any external system. The software may comprise application software, scripts and/or code that may be adapted to run on or within the hardware.

The sales integration engine or block 102 may comprise a plurality of functional blocks, each of which may be adapted to perform specialized data processing tasks. The exemplary sales integration engine or block 102 of FIG. 1a may comprise any one or more of a data synchronization block or engine 118, a service scheduler block 120, a service notification block 122, and an integration configurator block 124. In accordance with an embodiment of the invention, the data synchronization block 118 may be adapted to comprise at least one or more of a data mapping function, a data validation function, a data staging function, a key cross referencing and mapping function, and an integration communication interface that may permit communication with external systems.

FIG. 1b is a block diagram of an exemplary data synchronization block 118 in accordance with an embodiment of the invention. Referring to FIG. 1b, there is shown a data mapping function 182, a data validation function 184, a data staging function 186, a key cross referencing and mapping function 188, and an integration communication interface 190.

The data mapping function 182 of the data synchronization block 118 may be adapted to translate information from a first non-native format to a second format, the latter of which may be interpreted by the sales processing system. In this regard, the data mapping function 182 may comprise one or more mappers or translators that may be configured to convert information from various non-native formats to a format native to the sales processing system. For example, the data mapping function 182 may be adapted to convert hypertext markup language (HTML) formatted information into extensible markup language (XML) formatted information.

The data validation function 184 of the data synchronization block 118 may be adapted to validate information that has been processed or translated by the mapping function. The data validation function 184 may verify the integrity of the translated information to ensure its accuracy and consistency.

The data staging function 186 of the data synchronization block 118 may comprise one or more quality approval processes. In one embodiment of the invention, a quality approval process may be adapted to determine whether the information meets certain criteria and/or guidelines. The criteria and/or guidelines may be company based, standards based, industry based, de facto, and/or government based. For example, the quality approval process may ensure that company guidelines have been followed and that standardized processes and procedures such as ISO 9001 have been satisfied.

The key cross referencing and mapping function 188 of the data synchronization block 118 may be adapted to maintain a unique key cross-referencing between external systems and an internal sales processing system. In this regard, subsequent to the synchronization of information by the data synchronization block 118, the key cross referencing and mapping function 188 may be adapted to evaluate the data and determine possible associations that may inter-relate at least portions of the synchronized information.

The integration communication interface 190 of the data synchronization block 118 may be adapted to facilitate communication with one or more of a plurality of disparate and/or external systems. In this regard, the integration communication interface 190 may be adapted to communicate with, for example, an enterprise application integration (EAI) system or server. In accordance with an aspect of the invention, middleware may be utilized to integrate various application programs to ensure that information may be readily interchanged between, for example, databases, legacy systems and disparate systems that my contain relevant sales process data or information.

In an illustrative embodiment of the invention, in a case where it may be necessary to determine whether a particular candidate may be qualified for a particular job, the data mapping function 184 may be adapted to select an appropriate candidate from a plurality of candidates. The data validation function 184 may determine whether the candidate has the required qualifications, which may comprise academic and/or employment experience. The data staging function 186 may determine whether the credentials stated by the candidate are in fact genuine. Subsequent to synchronization of the information, the key cross referencing and mapping function 188 may be adapted to determine how the credentials of the candidate compares to other candidates that might have been hired in the past. In another example, the key mapping and cross referencing 188 function may be adapted to determine how the credentials of the candidate compares to other similar candidates hired by external companies.

The sales integration engine 102 may also comprise a service scheduler block 120. Since the sales integration engine 102 may communicate with a plurality of other information systems, the service scheduler block 120 may be adapted to control a frequency at which the sales integration engine 102 my acquire and/or update information. Notwithstanding, the sales integration engine 102 may also be adapted to control a duration allotted for acquiring and updating information for a particular system. For example, the service scheduler 120 may be adapted to query a particular customer information database at intervals, which may include, but are not limited to, every microsecond, every minute, every hour, once per day, once per week or at the end of every month. In an embodiment of the invention, a frequency at which the service integration engine 102 may acquire updates may be adaptively altered by the service scheduler 120. Accordingly, the service scheduler 120 may be adaptively configured to instruct the sales integration engine 102 to obtain updates from certain databases or information systems in real time. For example, the CRM block 130 in the information resources block 106 may be known to continually update its customer database throughout the day while customers call into a CRM call center. With this knowledge, the service scheduler 120 may be adapted to schedule the sales integration engine 102 to acquire information from the CRM block 130 at a frequency of, for example, every ten (10) minutes. In a case where the CRM block 130 may be known to update its customer database only at the close of business during the week, then the service scheduler 120 may be adapted to schedule the sales integration engine 102 to acquire information at midnight every day during the week.

The sales integration engine 102 may also comprise a service notifier block 122. Since the sales integration engine 102 communicates with a plurality of other systems, the service notifier 122 may oversee the operations of the sales integration engine to determine whether any errors occur in the operations of the sales integration engine 102. The service notifier 122 may be adapted to detect errors in the operations of the sales integration engine 102 without a need for manual intervention. However, the invention may not be limited in this regard and the service notifier block 122 may require manual intervention in certain circumstances. Depending on the type of business entity, various levels of severity of the errors may be defined. The type of business entity may include, but is not limited to, customer information, opportunity information and content related information. A content related business entity may have, for example, ten (10) severity levels, namely severity level one (1) through severity level ten (10). In this regard, severity level ten (1) may be the least severe error and severity level ten (10) may refer to the most severe error. In one embodiment of the invention, depending on the level of severity specific, notifications may be dispatched to selected sub-subsystems and/or persons.

The sales integration engine 102 may also comprise an integration configurator 124. In general, the sales integration engine 102 may be designed to be highly configurable. In this regard, the integration configurator 124 may facilitate speedy configuration of the sales integration engine 102 to meet the requirements of a particular business application. The integration configurator 124 may comprise one or more graphical user interfaces (GUIs) that may run on a terminal directly or remotely coupled to the sales processing system. The GUI may comprise selectable options that facilitate the selection of various parameters that may permit one or more of a plurality of operational modes for the sales integration engine 102. The GUI may also permit input of certain parameters that may affect the operation of the sales integration engine 102.

The integration configurator 124 may be configured to permit the sales integration engine 102 to interact with a plurality of systems without the need to engage in software modification. Once new parameters are entered into the integration configurator 124, the data synchronizer 118 may accordingly change the operations of the sales integration engine 102 to operate with the new parameters. Notably, whenever it may be desirable to make changes to the operations of the sales integration engine 102, these changes may be made to via the integration configurator 124. For example, in a case where specialized data may be received from specific ones of a plurality of information systems, the integration configurator 124 may instruct the sales integration engine 102 to acquire information from only those specified information systems.

In certain instances, it may be necessary to orchestrate the sequencing of data from a plurality of information systems. In a case where it may be appropriate to receive data from particular ones of the plurality of information systems prior to receiving data from other ones of the information systems, the integration configurator 124 may be configured to provide the appropriate sequence in which the data should be received. In another aspect of the invention, the integration configurator 124 configure how data may be received and processed. In this case, the integration configurator 124 may configure the sales integration engine 102 to receive incremental changes to a customer record or receive the complete customer record whenever a change has occurred in a customer record.

The integration configurator 124 may also be adapted to facilitate load balancing of the sales processing system. This may permit changes that dictate where and how particular sales process information may be processed within the system. In another aspect of the invention, in order to balance system load, the integration configurator 124 may also be configured to prioritize the execution of certain sales processes. Accordingly, to maintain a balanced load, the execution of certain sales processes may be pre-empted or temporarily suspended to facilitate execution of a less resource consuming sales process.

The integration configurator 124 may also be programmed to determine a number of subscribers to which data may be sent and also a number of systems from which data may be received. Furthermore, in another aspect of the invention, metadata required for the data synchronizer to execute its data mapping or translation function may also be stipulated by the integration configurator 124. In this regard, the integration configurator 124 may specify what languages may be necessary for proper translation and mapping.

The customer opportunities and data block 104 may comprise a sales process configurator 140 and any one or more of a product offerings data block 108, a verticals data block 110, a channels data block 112, a geographical data block 114 and a customers data block 116. The customer opportunities and data block 104 may further comprise a plurality of sales process or task 142a, 142b, 142c, collectively illustrated as 142. Each of the tasks may have a plurality of steps. For example, sales process or task 142a may comprise five (5) steps, namely S1, S2, S3, S4, S5. Each of the steps may also comprise a plurality of activities collectively illustrated as 144. For example, step S1 has activities A1, A2 and A3. At least some of the activities may have pre-requisites or required contents 146, 148.

The information resources block 106 may include, for example, one or more of a SAP block 126, an order management system (ODM) block 128, a customer relationship management (CRM) block 130, a document management system (DMS) block 132, a learning management system (LMS) block 134 and/or other resource block 136.

The SAP block 126 may be an information database that may be adapted to store and process SAP database related information. The order management system block 128 may be adapted to store product order information. The CRM block 130 may comprise a suite of products that may be integrated to provide the necessary infrastructure for implementing a channel for supporting sales process related activities. The CRM block 130 may be adapted to acquire, identify and retain customers. The document management system block 132 may be adapted to store and process sales documents. The learning management system block 134 may be adapted to function as a library system that may contain archived and historical information related to previous sales process transactions.

In the embodiment of the FIG. 1a, the sales integration engine or block 102 may comprise a plurality of interfaces, at least one which may be coupled to the customer opportunities and data block 104 and another of which may be coupled to the information resources block 106. The sales integration engine or block 102 may be configured to potentially connect any number of sales processes to any one or more of a plurality of external systems, which may contain information required by sellers. Information acquired from the external systems may be relevant to at least one or more of the various data contexts which may be included in the customer opportunities and data block 104, for example product offerings data block 108, verticals data block 110, channels data block 112, geographical data block 114 and customer data block 116. The external systems, may be for example, one or more external servers and/or databases which may store and/or distribute information. The sales integration engine or block 102 may be configured to connect with a plurality of external information systems. In one embodiment of the invention, the information exchange may occur in real time as changes to data occur.

The offers block 108, verticals block 110, channels block 112, geographical block 114 and customers block 116 may be classified as contexts within the customer opportunities and data block 104. The product offering data block 108 may include, but is not limited to, information such as product and/or service descriptions. A channel may be a particular communication medium or a logical medium that may be used to offer one or more sales activities. The channel context block 112 may define a manner in which a business caters to its customers. This may include, but is not limited to, a telephone based channel, a web based channel, a kiosk based channel, a field based channel, a storefront channel and/or mail order based channel.

In general, the verticals block 110 may refer to the different types of businesses and/or industries to which a particular business may cater. For example, an equipment manufacturer may cater to verticals including, finance, manufacturing, resellers, legal, and retail. The customer context block 116 may define the spectrum of actual and potential customers. The geographical context may include information pertaining to the location of a customer. Additionally, the geographical context may also include information pertaining to customer demographics.

The customer opportunities and data block 104 may comprise various sales processes or tasks 144, each of which may have a number of steps. For example, sales process or task 142a is shown having five steps, namely S1, S2, S3, S4, S5. Step S1 of sales process 142a has three (3) activities, namely A1, A2, A3. Step S2 of sales process 142a has four (4) activities, namely A1, A2, A3, A4. Step S3 of sales process 142a has two (2) activities, namely A1, A2. Step S4 of sales process 142a has three (3) activities, namely A1, A2, A3. Finally, step S5 of sales process 142a has four (4) activities, namely A1, A2, A3, A4. Activity A3 of step S2 requires prerequisite data or content 148 and activity A2 of step S5 requires prerequisite data 146. Accordingly, the prerequisite data or content 148 may be required for the completion of activity A3. Similarly, the prerequisite data or content 146 may be required for the completion of activity A2. Each of the activities for a particular task may require information from an external information system. The required information may be external to the sales integration system 102. In accordance with the invention, a collection of steps and activities and any perquisite data or content may form a sales process.

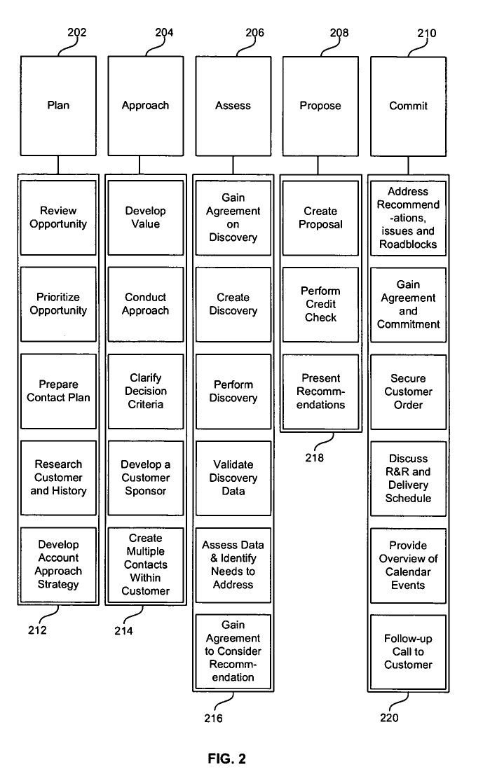

FIG. 2 is a block diagram of an exemplary sales process in accordance with an embodiment of the invention. Referring to FIG. 2, there is shown a plurality of steps, namely plan step 202, approach step 204, assess step 206, propose step 208 and commit step 210. Each of steps 202, 204, 206, 208, 210 may comprise one or more activities.

The plan step 202 may have five (5) activities, collectively referenced as 212. These activities 212 may comprise a review opportunity activity, prioritize opportunity activity, prepare contact plan activity, research customer and history activity, and develop account approach strategy. The review opportunity activity may include a review of some or all the relevant issues related to the sales opportunity. The prioritize opportunity activity may include prioritizing the relevant issues and tasks involved with the sales opportunity. The prepare contact plan activity may include preparing a list of possible contacts and the roles and extent to which each contact might be involved. The research customer and history activity may include doing various searches in order to acquire information that may provide a synopsis of the company, including its history and performance. Varying levels searching may be done depending on the depth and breadth of the information required. The develop account approach strategy activity may include developing a feasible account approach strategy.

The approach step 204 may have, for example, five (5) activities, collectively referenced as 214. These activities 214 may include a develop value activity, a conduct approach activity, a clarify decision criteria activity, a develop a customer sponsor activity and finally, a create multiple contacts within customer activity. The develop value activity may include creating a strategy on how best to approach a customer and how best to deliver a plan to the customer. The conduct approach activity may include strategizing how best to build customer awareness and stimulate a customer's interest. The develop customer sponsor activity may include the development of a sponsor efforts within a customer's environment to support sales related activities. The create multiple contacts within customer activity may include ascertaining which contacts within, for example a company, may be beneficial to the sales opportunity.

The assess step 206 may have six (6) activities, collectively referenced as 216. These activities 216 may comprise a gain agreement on discovery activity, a create discovery activity, a perform discovery activity, a validate discovery activity, an assess data and identify need to address activity and finally, a gain agreement to consider recommendation activity. The gain agreement on discovery activity may include determining the scope and nature of the agreement and the parties and/or entities that may be involved in any agreement effort. The create discovery activity may include, for example, the creation of a questionnaire. The validate discovery data activity may include the step of validating and verifying the content of any material discovered. Since the perform discovery activity may be a critical activity to the assess step 206, the perform discovery activity may be denoted as a mandatory activity. The assess data and identify need to address activity may include identifying customer needs and formulating how best to satisfy those needs. The gain agreement to consider recommendation activity may include gaining agreement on acceptance of any recommendations that may be made.

The propose step 208 may have three (3) activities, collectively referenced as 218. These activities 218 may comprise a create proposal activity, a perform credit check activity, and finally, a present recommendations activity. The create proposal activity may include the creation of various proposals and recommendations pertinent to the sales strategy. Since the perform credit check activity may be a critical activity to the propose step 208, the perform credit check activity may be denoted as a mandatory activity. The present recommendations activity may include the presentation of recommendations to key decision makers and players related to the sales opportunity and/or activity.

The commit step 210 may include, for example, six (6) activities, collectively referenced as 220. These activities 220 may comprise an address recommendations, issues and roadblocks activity, gain agreement and commitment activity, secure customer order activity, discuss recommendations, road blocks and delivery schedule activity, provide overview of calendar events activity, and follow-up call to customer activity. The address recommendations, issues and roadblocks activity may include deciding how best to handle roadblocks that have been encountered or may be encountered. The gain agreement on discovery activity may include finalizing the scope and nature of the agreement with the parties and/or entities involved in the agreement effort. The secure customer order activity may include acquiring an order for certain products and/or services from the customer. The discuss recommendations, road blocks and delivery schedule my include discussing any roadblocks that may be encountered or will be encountered during delivery of the product and/or service. The provide overview of calendar events activity may include creating a timeline of the events related to the sales process. For example, a timeline may be created to track the deliverables. Since the follow-up call activity may be a critical activity to the commit step 210, the follow-up call to customer activity may be denoted as a mandatory activity.

In operation, the sales integration engine 102 may be adapted to acquire pertinent information from a resource in the information resources block 106 in real time. In this regard, the sales integration engine 102 may acquire the information within the contexts of the offers 108, verticals 110, channels 112, geographical 114 and customers 116, for a specific sales process, and for a particular activity within the sales process. Once the information is acquired, the sales integration engine 102 may processes the acquired information.

In accordance with an embodiment of the invention, the sales integration engine 102 of FIG. 2 may be configured to acquire the sales process information from at least one of a plurality of information resources and create a historical information store using the acquired sales process information. The sales integration engine 102 may create rules based on the acquired sales process information in the historical information store and may generate a sales process from at least a portion of the created rules. The historical information store may comprise a database or other data storage entity that may be adapted to store a history of related sales processes, sales process rules and/or sales process activities.

The sales integration engine 102 may comprise at least one of a data synchronizer 118, a service scheduler 120, a service notifier 122 and an integration configurator 124. In response to a request to create a sales process, the sales integration engine 102 may determine whether matching sales process information corresponding to the request is located in the historical information store. The sales integration engine 102 may be adapted to utilize at least a portion of the matching sales process information to generate the sales process if matching sales process information corresponding to the request is located in the historical information store.

In instances where no matching sales process information corresponding to the request is found or located within the historical information store, the sales integration engine 102 may generate new rules corresponding to the request to create the sales process. In this regard, the sales integration engine 102 may be configured to dynamically generate the new rules which may correspond to the request to create the sales process. Notwithstanding, the sales integration engine 102 may define sales processing steps and/or sales processing activities corresponding to the newly generated rules.

In another aspect of the invention, the sales integration engine 102 may be configured to select at least one of the sales processing activities and/or the sales processing steps for generating the sales process. In instances where no matching sales process information corresponding to the request is located in the historical information store, the sales integration engine 102 may analogize based on at least similar sales process information, similar sales processing activities or similar sales processing steps that may be located in the historical information store, in order to generate the sales process engine. If no matching sales process information corresponding to the request is located in the historical information store, the sales integration engine 102 may be adapted to hypothesize based on sales process information located in the historical information store, in order to generate the sales process.

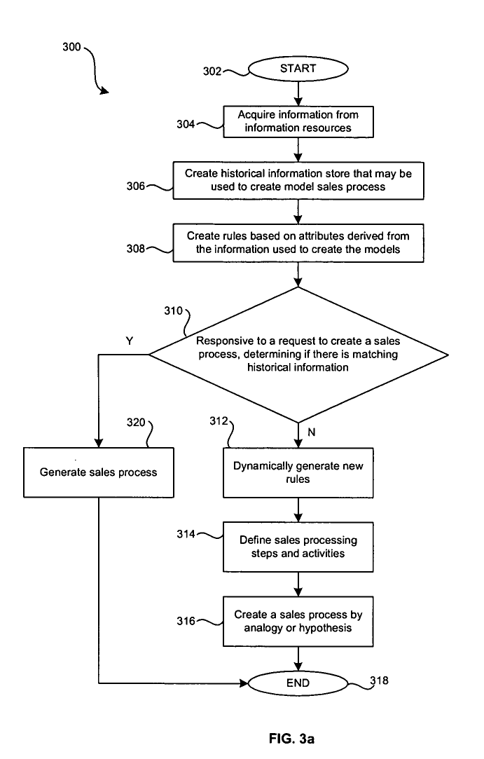

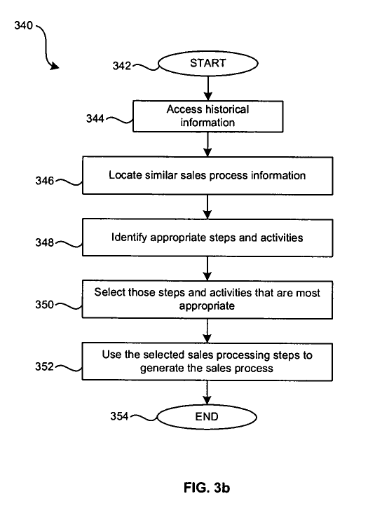

FIG. 3a is a flow chart 300 of exemplary steps for processing sales processing information in accordance with an aspect of the invention. Referring to FIG. 3a, the exemplary steps may start at step 302. In step 304, sales process information may be acquired from one more of a plurality of information resources. In step 306, a historical information store of the sales process information may be created and used to model various sales processes. In step 308, rules may be created based on attributes derived from the sales process information, which may be used to create the sales process model. In step 310, in response to a request to create a sales process, a decision may be made as to whether there is any matching and/or pertinent historical information in the information store. If there is matching historical information, then in step 320, a sales process may be generated. In step 310, if there is no matching historical information, then in step 312, new rules may be dynamically generated. In one aspect of the invention, an iterative process may be used the dynamically generate new rules. Subsequently, in step 314, various sales processing steps and activities may be defined. In step 316, a sales process may be created by analogy and/or hypothesis. Subsequent to execution of steps 320 or step 316, execution may end at step 318.

FIG. 3b is a flow chart 340 of exemplary steps for generating the sales process in step 320 of FIG. 3a in accordance with an aspect of the invention. Referring to FIG. 3b, the exemplary steps may start at step 342. In step 344, historical information may be accessed. In step 346, similar sales process information may be located. In step 348, appropriate steps and/or activities may be identified. In step 350, the identified steps and/or activities that are most appropriate or which provide a fit, may be selected. In step 352, the selected sales processing steps may be used to generate the sales process. Execution may end at step 354. Although historical information may be generated by the sales integration engine, the invention is not limited in this regard. Accordingly, historical information may also be imported from one or more external sources, and/or manually generated and/or inputted by a user.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing sales process information, the method comprising:
acquiring the sales process information from at least one of a plurality of information resources;
creating historical information store using said acquired sales process information;
creating rules based on said acquired sales process information in said historical information store; and
generating a sales process from at least a portion of said created rules.

2. The method according to claim 1, further comprising in response to a request to create a sales process, determining whether matching sales process information corresponding to said request is located in said historical information store.

3. The method according to claim 2, further comprising if matching sales process information corresponding to said request is located in said historical information store, utilizing at least a portion of said matching sales process information for said generating of said sales process.

4. The method according to claim 2, further comprising if no matching sales process information corresponding to said request is located in said historical information store, generating new rules corresponding to said request to create said sales process.

5. The method according to claim 4, further comprising dynamically generating said new rules corresponding to said request to create said sales process.

6. The method according to claim 4, further comprising defining sales processing steps corresponding to said generated new rules.

7. The method according to claim 4, further comprising defining at least one of sales processing activities and sales processing steps corresponding to said generated new rules.

8. The method according to claim 7, further comprising selecting said at least one of said sales processing activities and said sales processing steps for said generating of said sales process.

9. The method according to claim 4, further comprising if no matching sales process information corresponding to said request is located in said historical information store, analogizing based on at least similar sales process information, similar sales processing activities or similar sales processing steps located in said historical information store, in order to generate said sales process.

10. The method according to claim 4, further comprising if no matching sales process information corresponding to said request is located in said historical information store, hypothesizing based on sales process information located in said historical information store, in order to generate said sales process.

11. A machine-readable storage having stored thereon, a computer program having at least one code section for processing sales process information, the at least one code section being executable by a machine for causing the machine to perform steps comprising:
acquiring the sales process information from at least one of a plurality of information resources;
creating a historical information store using said acquired sales process information;
creating rules based on said acquired sales process information in said historical information store; and
generating a sales process from at least a portion of said created rules.

12. The machine-readable storage according to claim 11, further comprising code for determining whether matching sales process information corresponding to said request is located in said historical information store, in response to a request to create a sales process.

13. The machine-readable storage according to claim 12, further comprising code for utilizing at least a portion of said matching sales process information for said generating of said sales process, if matching sales process information corresponding to said request is located in said historical information store.

14. The machine-readable storage according to claim 12, further comprising code for generating new rules corresponding to said request to create said sales process, if no matching sales process information corresponding to said request is located in said historical information store.

15. The machine-readable storage according to claim 14, further comprising code for dynamically generating said new rules corresponding to said request to create said sales process.

16. The machine-readable storage according to claim 14, further comprising code for defining sales processing steps corresponding to said generated new rules.

17. The machine-readable storage according to claim 14, further comprising code for defining at least one of sales processing activities and sales processing steps corresponding to said generated new rules.

18. The machine-readable storage according to claim 17, further comprising code for selecting said at least one of said sales processing activities and said sales processing steps for said generating of said sales process.

19. The machine-readable storage according to claim 14, further comprising code for analogizing based on at least similar sales process information, similar sales processing activities or similar sales processing steps located in said historical information store, in order to generate said sales process, if no matching sales process information corresponding to said request is located in said historical information store.

20. The machine-readable storage according to claim 14, further comprising code for hypothesizing based on sales process information located in said historical information store, in order to generate said sales process, if no matching sales process information corresponding to said request is located in said historical information store.

21. A system for processing sales process information, the system comprising:
a sales integration engine that acquires the sales process information from at least one of a plurality of information resources;
said sales integration engine creates a historical information store using said acquired sales process information;
said sales integration engine creates rules based on said acquired sales process information in said historical information store; and
said sales integration engine generates a sales process from at least a portion of said created rules.

22. The system according to claim 21, wherein said sales integration engine determines whether matching sales process information corresponding to said request is located in said historical information store in response to a request to create a sales process.

23. The system according to claim 22, wherein said sales integration engine utilizes at least a portion of said matching sales process information for said generating of said sales process if matching sales process information corresponding to said request is located in said historical information store.

24. The system according to claim 22, wherein said sales integration engine generates new rules corresponding to said request to create said sales process if no matching sales process information corresponding to said request is located in said historical information store.

25. The system according to claim 24, wherein said sales integration engine dynamically generates said new rules corresponding to said request to create said sales process.

26. The system according to claim 24, wherein said sales integration engine defines sales processing steps corresponding to said generated new rules.

27. The system according to claim 24, wherein said sales integration engine defines at least one of sales processing activities and sales processing steps corresponding to said generated new rules.

28. The system according to claim 27, wherein said sales integration engine selects said at least one of said sales processing activities and said sales processing steps for said generating of said sales process.

29. The system according to claim 24, wherein said sales integration engine analogizes based on at least similar sales process information, similar sales processing activities or similar sales processing steps located in said historical information store, in order to generate said sales process engine if no matching sales process information corresponding to said request is located in said historical information store.

30. The system according to claim 24, wherein said sales integration engine hypothesizes based on sales process information located in said historical information store, in order to generate said sales process if no matching sales process information corresponding to said request is located in said historical information store.

31. The system according to claim 30, wherein said sales integration engine comprises at least one of a data synchronizer, a service scheduler, a service notifier and an integration configurator.
